(19) United States
(12) Patent Application Publication
(10) Pub. No.: US 2025/0260108 A1
(43) Pub. Date: Aug. 14, 2025

(54) Protective Structures for Battery Enclosures

(71) Applicant: ADVANCED INNERGY LTD., Gloucester (GB)

(72) Inventors: Laura Louise Jordan, Gloucester (GB); Simon Jones, Gloucester (GB)

(21) Appl. No.: 18/856,558

(22) PCT Filed: Feb. 17, 2023
(86) PCT No.: PCT/GB2023/050366

§ 371 Date: Oct. 11, 2024

(30) Foreign Application Priority Data
Apr. 12, 2022 (GB) 2205402.7

(51) Int. Cl. H01M 50/231; H01M 50/222; H01M 50/227; H01M 50/229; H01M 50/249

(52) U.S. Cl. CPC H01M 50/231; H01M 50/222; H01M 50/227; H01M 50/229; H01M 50/249; H01M 2220/20

(57) ABSTRACT

A protective structure for protecting a battery enclosure. The protective structure includes a functional layer and a reinforcing layer. The functional layer includes a fire retardant and a refractory material or an intumescent additive.

### CROSS REFERENCE TO RELATED APPLICATIONS

The present application is a U.S. National Stage Application of PCT/GB2023/050366 filed on Feb. 17, 2023, which claims the benefit of priority to Great Britain Patent Application No. 2205402.7 filed on Apr. 12, 2022, the disclosures of which are hereby incorporated by reference in their entireties.

### TECHNOLOGICAL FIELD

Embodiments of the present disclosure relate to a protective structure for a battery enclosure, a battery enclosure comprising the protective structure, a vehicle comprising the battery enclosure, a method of forming the protective structure, and a method of protecting a battery enclosure.

### BACKGROUND

Battery packs have a number of applications, for instance in electric vehicles, in the aerospace industry, and for use as storage in an electric power grid. The battery packs comprise a number of battery cells within an enclosure. The enclosure separates the battery cells from the surrounding area, which could for instance be the chassis of an electric vehicle.

Batteries, which are commonly lithium-ion batteries, are susceptible to thermal runaway events. These events can be caused by overheating, a short-circuit or mechanical damage to the battery cells. Some battery cells also have minor manufacturing defects, which could cause a thermal runaway event during normal charge or discharge cycles.

A thermal runaway event often involves the release of burning gas at high pressure and temperatures of around 1200° C., and can propagate between cells within the battery pack, leading to a chain reaction. The walls of the enclosure often do not provide sufficient protection from such events. Therefore, the energy from the runaway event can escape the enclosure, creating a safety hazard and causing damage to the surrounding area. It is therefore desirable to provide protective structures for protecting battery enclosures.

### BRIEF SUMMARY

According to various, but not necessarily all, embodiments there is provided a protective structure for protecting a battery enclosure, the protective structure comprising:
a functional layer comprising a cured polymer, wherein the functional layer comprises a fire retardant and a refractory material dispersed in the cured polymer, or wherein the functional layer comprises an intumescent additive dispersed in the cured polymer; and
a reinforcing layer.

Possibly, in use, the functional layer of the protective structure is an outermost layer of the protective structure, the outermost layer defining an exposed surface. Possibly, in use, the reinforcing layer of the protective structure is an outermost layer of the protective structure, the outermost layer defining an exposed surface.

Possibly, the protective structure is for protecting an internal surface of a battery enclosure. Possibly, in use, the functional layer of the protective structure is an outermost layer of the protective structure and is exposed to an internal environment of the battery enclosure. Possibly, in use, the reinforcing layer of the protective structure is an outermost layer of the protective structure and is exposed to an internal environment of the battery enclosure.

Possibly, the reinforcing layer is in the form of a reinforcing sheet, the reinforcing sheet comprising a fabric or a mesh. The fabric or mesh may be made at least partially from: glass fibers, basalt fibers, mineral fibers, ceramic fibers, carbon fibers, or steel.

The reinforcing sheet may comprise a fabric with a weight of 50 to 1600 gsm. The reinforcing sheet may comprise a fabric with a weight of 50 to 250 gsm. Alternatively, the reinforcing sheet may comprise a fabric with a weight of 200 to 1600 gsm.

The cured polymer may comprise a silicone polymer, an epoxy resin, a silane terminated polymer resin, an acrylic resin, an alkyd resin, a vinyl acetate copolymer or a combination thereof.

The fire retardant may comprise an endothermic additive. The endothermic additive may comprise an inorganic salt. The inorganic salt may be aluminum trihydroxide, magnesium dihydroxide or ammonium polyphosphate.

The refractory material may comprise mica, clay, organoclay, talc, ceramic fibers or a borate.

The intumescent additive may comprise a phosphorus containing compound, a gas source, and a carbon source. Possibly, the phosphorus containing compound comprises ammonium polyphosphate, triphenyl phosphate, or aluminum phosphinate; the gas source comprises melamine or boric acid; and the carbon source comprises pentaerythritol or tris-(2-hydroxyethyl) isocyanurate. In some examples, tris-(2-hydroxyethyl) isocyanurate can be used as a gas source. Accordingly, tris-(2-hydroxyethyl) isocyanurate may be a carbon source and/or a gas source.

The functional layer may comprise a vitrifiable additive dispersed in the cured polymer. The vitrifiable additive may comprise a glass frit or a ceramifying agent.

The functional layer may have a thickness of 50 to 1000 microns.

The protective structure may further comprise an adhesive layer for attaching the protective structure to a surface of a battery enclosure. The adhesive layer may comprise a double-sided adhesive film or wet contact adhesive.

The protective structure may be flexible. The protective structure may have a thickness of 50 to 5000 microns.

According to various, but not necessarily all, embodiments there is provided a battery enclosure comprising the protective structure according to any of the preceding paragraphs.

Possibly, the battery enclosure comprises at least a first wall, wherein the reinforcing layer is located at least partially between the first wall and the functional layer.

Possibly, the battery enclosure comprises at least a first wall, wherein the functional layer is located at least partially between the first wall and the reinforcing layer.

According to various, but not necessarily all, embodiments there is provided a vehicle comprising the battery enclosure according to the above paragraph.

According to various, but not necessarily all, embodiments there is provided a method for protecting a battery enclosure, the method comprising attaching the protective structure of any of the above paragraphs to a surface of a battery enclosure.

Possibly, the method comprises attaching the protective structure to an internal surface of a battery enclosure.

According to various, but not necessarily all, embodiments there is provided examples as claimed in the appended claims.

### BRIEF DESCRIPTION

For a better understanding of various examples that are useful for understanding the detailed description, reference will now be made by way of example only.

### DETAILED DESCRIPTION

The disclosure provides a protective structure for protecting a battery enclosure. In some examples, the protective structure is for protecting an internal surface of a battery enclosure.

The protective structure comprises a functional layer and a reinforcing layer. The functional layer comprises a cured polymer and one or more additives (as described below) dispersed in the cured polymer. The cured polymer and additives are selected according to a required performance of the functional layer during a thermal runaway event.

In some instances, the cured polymer is a resin. For the avoidance of doubt, the resin referred to herein is a cured resin unless specified otherwise, rather than a resin precursor(s). The resin could also be considered as a polymeric material.

In some examples, the functional layer comprises a fire retardant and a refractory material dispersed in the cured polymer. In such examples, the fire retardant and the refractory material are additives comprised in the functional layer. In other examples, the functional layer comprises an intumescent additive dispersed in the cured polymer. In such examples, the intumescent additive is an additive comprised in the functional layer.

The disclosure also provides a battery enclosure comprising the protective structure, and a vehicle comprising the battery enclosure. The disclosure also provides a method for protecting a battery enclosure, the method comprising attaching the protective structure to a surface of a battery enclosure.

The protective structure protects the battery enclosure from a thermal runaway event.

The battery enclosure accommodates one or more battery cells. The battery enclosure comprises a plurality of walls for enclosing the battery cells. The walls of the battery enclosure define a cavity for locating the battery cells. In some examples, the battery enclosure has six walls and forms a cuboid shape, i.e., the battery enclosure includes an upper wall, a lower wall, and four side walls. In other examples, the battery enclosure may have a more complex shape, for instance including one or more curved walls. One or more of the walls of the battery enclosure may act as a lid to allow access into the battery enclosure. Preferably, the battery enclosure is moisture sealed to prevent the ingress of water into the cavity. The battery enclosure may also include one or more brackets for holding the battery cells in place within the enclosure. The battery enclosure also contains a battery cooling apparatus in some examples, which may be an air-cooling system or a fluid-cooling system.

The walls of the battery enclosure are preferably made from a rigid material, such as steel, aluminum, a rigid polymeric material, or a composite. The composite may be a sheet mounding compound (SMC), otherwise known as a sheet molding composite. Sheet molding compounds are produced by dispersing strands of chopped fiber (such as glass fibers or carbon fibers) within a thermoset resin.

In some examples, the battery enclosure forms part of a vehicle, such as an electric car. The battery enclosure may be secured to a frame of the vehicle, such as below a floor of the vehicle and generally between the axles.

An internal surface of a battery enclosure protected by the protective structure could be for instance the internal face of a wall of the battery enclosure (i.e., the surface of the wall facing into the cavity of the battery enclosure). The protective structure may cover a portion or substantially all of the inside surface of the walls, to inhibit the escape of the energy of a thermal runaway event from the enclosure.

In some examples, the protective structure has a thickness of 50 microns to 5000 microns. Preferably, the protective structure has a thickness of 200 microns to 2000 microns.

In some examples, the cured polymer is flexible. In some examples, the cured polymer has a Shore A hardness of up to 80. The cured polymer may be a silicone polymer, an epoxy resin, a silane terminated polymer resin, an acrylic resin, an alkyd resin, a vinyl acetate copolymer, or a combination thereof. The cured polymer may be a copolymer, for example a copolymer resin.

Other components (i.e., additives) comprised in the functional layer are dispersed in the cured polymer. Preferably, the functional layer has a thickness of 50 microns to 1000 microns.

In some examples, the reinforcing layer is in the form of a reinforcing sheet. The reinforcing layer can be considered as a strengthening component. The reinforcing layer has a higher tensile strength and/or tear strength than the functional layer, and thus improves the tensile strength and/or tear strength of the protective structure.

The reinforcing sheet may comprise a fabric or a mesh. The fabric or mesh may be made partially or wholly from glass fibers (such as high silica glass), basalt fibers, mineral fibers, ceramic fibers, carbon fibers, steel, or a combination of any of these materials. The fabric may be woven or non-woven.

In some examples, the fabric has a weight of 50 to 1600 gsm. Preferably, the fabric has a weight of 300 to 900 gsm. In one preferred example, the fabric is a glass woven fabric with a weight of 600 gsm. In some examples, the reinforcing sheet comprises a fabric with a weight of 50 to 250 gsm. In other examples, the reinforcing sheet comprises a fabric with a weight of 200 to 1600 gsm.

In some examples, reinforcing fibers may be dispersed in the cured polymer of the functional layer. The reinforcing fibers may be basalt fibers, glass fibers, ceramic fibers, carbon fibers, and/or mineral fibers.

In examples in which the functional layer comprises a fire retardant and a refractory material dispersed in the cured polymer; the fire retardant inhibits combustion of the functional layer during a thermal runaway event. Preferably, the fire retardant comprises an endothermic additive, such as an inorganic salt.

The endothermic additive acts to cool the functional layer by an endothermic reaction in the presence of heat. The inorganic salt can evolve a non-flammable gas such as water or carbon dioxide at elevated temperatures, thereby removing heat from the functional layer.

The inorganic salt may be aluminum trihydroxide, magnesium dihydroxide or ammonium polyphosphate. In some examples, the fire retardant comprises a further endothermic additive. The further endothermic additive could be for instance a different inorganic salt.

In such examples, the refractory material is removed or destroyed (e.g., by erosion or charring) in the presence of a flame. The refractory material can block a flame or heat for a limited period, until the refractory material is fully spent. In some examples, the refractory material comprises a mineral or a ceramic. Preferably, the refractory material comprises mica, clay, organoclay, talc, ceramic fibers or a borate. A refractory material is an ablative or ablative additive.

In examples in which the functional layer comprises an intumescent additive dispersed in the cured polymer; the intumescent additive expands upon exposure to heat, thereby providing a low density, protective, foam like layer, to insulate a substrate from heat.

In some examples, the intumescent additive comprises a phosphorus containing compound, a gas source, and a carbon source. The phosphorus containing compound could be for instance ammonium polyphosphate, triphenyl phosphate, or aluminum phosphinate. The gas source could be for instance melamine or boric acid. The carbon source could be for instance pentaerythritol or tris-(2-hydroxyethyl) isocyanurate.

In some examples, tris-(2-hydroxyethyl) isocyanurate can be used as a gas source. Accordingly, tris-(2-hydroxyethyl) isocyanurate may be a carbon source and/or a gas source.

In some examples, the functional layer comprises a vitrifiable additive dispersed in the cured polymer. A vitrifiable additive vitrifies/ceramifies when exposed to heat, thereby forming a solid or glass like layer that resists high pressure and erosion. Preferably, the vitrifiable additive comprises a glass frit or a ceramifying agent. An example glass frit is the Ferro® 14019 frit, and example ceramifying agents include the Ceepree® CGB 3BAM additive and the Johnson Matthey® XF®T inorganic additives.

In some examples, the protective structure further comprises an adhesive layer for attaching the protective structure to a surface of a battery enclosure. Preferably, the adhesive layer comprises a double-sided adhesive tape, such as a double-sided acrylic adhesive tape. In other examples, the adhesive layer can be applied as a liquid (e.g., via spraying or using a brush), for instance using a liquid polymer adhesive such as a liquid acrylic adhesive, a liquid neoprene adhesive, a liquid silicone adhesive, a liquid polyurethane adhesive, or a liquid epoxy adhesive.

Alternatively, or additionally to the use of adhesive to attach the protective structure to a surface of a battery enclosure, the protective structure can be mechanically attached to a surface of a battery enclosure. This can be achieved using fasteners such as staples or rivets, or by providing a slot in a surface of a battery enclosure, the slot being arranged to allow insertion of at least part of the protective structure.

In some examples, the reinforcing layer is located between the adhesive layer and the functional layer. The reinforcing layer can thus act as an adhesion aid between the functional layer and the adhesive layer.

In some examples, in use, the functional layer of the protective structure is an outermost layer of the protective structure. In other examples, in use, the reinforcing layer of the protective structure is an outermost layer of the protective structure. The outermost layer of the protective structure is the layer of the protective structure furthest from the surface of a battery enclosure to which it is attached. In use, the outermost layer of the protective structure defines an exposed surface. In such examples, the surface of a battery enclosure to which the protective structure is attached may be an internal surface or external surface of the battery enclosure.

In some examples wherein the protective structure is for protecting an internal surface of a battery enclosure, in use, the functional layer of the protective structure is an outermost layer of the protective structure and is exposed to an internal environment of the battery enclosure. The functional layer is therefore an exposed surface layer on the inside of the battery enclosure. Accordingly, the reinforcing layer is located at least partially between a first wall of the battery enclosure and the functional layer.

In other examples wherein the protective structure is for protecting an internal surface of a battery enclosure, in use, the reinforcing layer of the protective structure is an outermost layer of the protective structure and is exposed to an internal environment of the battery enclosure. The reinforcing layer is therefore an exposed surface layer on the inside of the battery enclosure. Accordingly, the functional layer is located at least partially between a first wall of the battery enclosure and the reinforcing layer.

The in use outermost layer of the protective structure provides an innermost surface of the protected battery enclosure and is thus, in use, exposed to an internal environment of the battery enclosure.

An ‘in use’ condition of the protective structure means that the protective structure is attached to a surface of the battery enclosure.

Example protective structures are described below.

### Protective Structure (Example 1)

A first example of a protective structure was made up of a functional layer, a reinforcing layer, and optionally an adhesive layer for attaching the protective structure to an internal surface of a battery enclosure.

In this example, the functional layer provides an in use outermost layer of the protective structure and is exposed to an internal environment of the battery enclosure.

If present, the adhesive layer provides an in use innermost layer and may comprise a film of contact adhesive with protective film (i.e., a double-sided adhesive film) that allows easy bonding to the surface to be protected. The effect can also be achieved by mechanical fix or application of wet contact adhesive.

### Functional Layer

The functional layer is the cured reaction product of a mixture having the components listed below. In example 1, the functional layer comprises a fire retardant and a refractory material dispersed in the cured polymer.

| | | Quantity |
|---|---|---|
| Component | Specific example of component | (wt. %) |
| Curable silicone polymer | Vinyl terminated | 32 |
| | polydimethylsiloxane | |
| Silicone crosslinker & | Polydimethylhydrogen siloxane | 3 |
| catalyst | with hydrosilylation catalyst | |
| Fire retardant | Aluminum trihydroxide | 7.5 |
| Fire retardant | Ammonium polyphosphate | 16 |
| Vitrifiable additive | Glass frit | 22 |
| Refractory material | Organoclay | 1 |
| Refractory material | Mica flakes | 11 |
| Processing aid | Solvent | 7.5 |

### Reinforcing Layer

The reinforcing layer is in the form of a reinforcing sheet comprising a fabric. In this example, the fabric is made from glass fibers, typically high silica glass. The fabric has a weight of 200 to 1600 gsm, and may have a weight of 600 gsm. The fabric is a high temperature fabric or felt with a significant thickness capable of resisting a 1200° C. gas jet without melting.

Example 1 provides resistance to penetration during a thermal runaway event. As detailed above, it is made up of an outer/exposed surface functional layer. The functional layer is loaded with fire retardant and refractory materials to form a hard resistant char. This is the first layer of defense against erosion. The functional layer is applied to the reinforcing layer to provide structure, resistance to the pressure of gas jets and additional resistance to penetration and erosion.

### Protective Structure (Example 2)

A second example of a protective structure was made up of a functional layer, a reinforcing layer, and optionally an adhesive layer for attaching the protective structure to an internal surface of a battery enclosure.

In this example, the functional layer provides an in use outermost layer of the protective structure and is exposed to an internal environment of the battery enclosure.

If present, the adhesive layer provides an in use innermost layer and may comprise a film of contact adhesive with protective film (i.e., a double-sided adhesive film) that allows easy bonding to the surface to be protected. The effect can also be achieved by mechanical fix or application of wet contact adhesive.

### Functional Layer

The functional layer is the cured reaction product of a mixture having the components listed below. In example 2, the functional layer comprises a fire retardant and a refractory material dispersed in the cured polymer.

| | | Quantity |
|---|---|---|
| Component | Specific example of component | (wt. %) |
| Curable epoxy polymer | Bisphenol A | 14 |
| Epoxy crosslinker | Amine-based epoxy cross- | 3 |
| | linking agent, e.g., | |
| | isophorone diamine (IPDA) | |
| Curable silane | Silane terminated polyether | 13.5 |
| terminated polymer | | |
| Aminosilane crosslinker | Aminopropyltrimethoxysilane | 1.5 |
| Fire retardant | Aluminum trihydroxide | 7.5 |
| Fire retardant | Ammonium polyphosphate | 16 |
| Vitrifiable additive | Glass frit | 21 |
| Refractory material | Organoclay | 1 |
| Refractory material | Mica flakes | 10.5 |
| Processing aid | Solvent | 10.5 |
| Processing aid | Rheology modifier | 0.5 |
| Processing aid | Dispersing agent | 1 |

### Reinforcing Layer

The reinforcing layer is in the form of a reinforcing sheet comprising a fabric. In this example, the fabric is made from glass fibers, typically high silica glass. The fabric has a weight of 200 to 1600 gsm, and may have a weight of 600 gsm. The fabric is a high temperature fabric or felt with a significant thickness capable of resisting a 1200° C. gas jet without melting.

Example 2 provides resistance to penetration during a thermal runaway event. As detailed above, it is made up of an outer/exposed surface functional layer. The functional layer is loaded with fire retardant and refractory materials to form a hard resistant char. This is the first layer of defense against erosion. The functional layer is applied to the reinforcing layer to provide structure, resistance to the pressure of gas jets and additional resistance to penetration and erosion.

### Protective Structure (Example 3)

A third example of a protective structure was made up of a functional layer, a reinforcing layer, and optionally an adhesive layer for attaching the protective structure to an internal surface of a battery enclosure.

In this example, the functional layer provides an in use outermost layer of the protective structure and is exposed to an internal environment of the battery enclosure.

If present, the adhesive layer provides an in use innermost layer and may comprise a film of contact adhesive with protective film (i.e., a double-sided adhesive film) that allows easy bonding to the surface to be protected. The effect can also be achieved by mechanical fix or application of wet contact adhesive.

### Functional Layer

The functional layer is the cured reaction product of a mixture having the components listed below. In example 3, the functional layer comprises an intumescent additive dispersed in the cured polymer.

| | | Quantity |
|---|---|---|
| Component | Specific example of component | (wt. %) |
| Curable silicone polymer | Vinyl terminated | 28 |
| | polydimethylsiloxane | |
| Silicone crosslinker & | Polydimethylhydrogen siloxane | 3 |
| catalyst | with hydrosilylation catalyst | |
| Intumescent additive | Ammonium polyphosphate (APP) | 30 |
| | Melamine | 10 |
| | Pentaerythritol | 9 |
| | Titanium dioxide | 9 |
| | Zinc borate | 2 |
| Processing aid | Solvent | 9 |

### Reinforcing Layer

The reinforcing layer is in the form of a reinforcing sheet comprising a fabric. In this example, the fabric is glass paper. The fabric has a weight of 50 to 250 gsm.

Example 3 provides insulation and heat absorption during a thermal runaway event.

In this example, the in use outermost layer of the protective structure is the functional layer comprising the intumescent additive. The intumescent additive will expand by three times or more to provide a low-density char. This is very insulative but is vulnerable to erosion, therefore it is not well suited to areas close to the initial vent where gas velocities are high.

The reinforcing layer here is much less critical because it is not intended to resist penetration. Typically, the reinforcing layer is a thinner and cheaper layer (compared to examples 1 and 2 above), for example glass paper. The function of the reinforcing layer is largely to provide a substrate to lay the functional layer (i.e., intumescent film) down onto, and also to provide a keying layer for the adhesive film (if present).

### Protective Structure (Example 4)

A fourth example of a protective structure was made up of a functional layer, a reinforcing layer, and optionally an adhesive layer for attaching the protective structure to an internal surface of a battery enclosure.

In this example, the functional layer provides an in use outermost layer of the protective structure and is exposed to an internal environment of the battery enclosure.

If present, the adhesive layer provides an in use innermost layer and may comprise a film of contact adhesive with protective film (i.e., a double-sided adhesive film) that allows easy bonding to the surface to be protected. The effect can also be achieved by mechanical fix or application of wet contact adhesive.

### Functional Layer

The functional layer is the cured reaction product of a mixture having the components listed below. In example 4, the functional layer comprises an intumescent additive dispersed in the cured polymer.

| Component | Specific example of component | Quantity (wt. %) |
|---|---|---|
| curable epoxy polymer | bisphenol A epoxy resin | 14 |
| amine based epoxy curing agent | isophorone diamine (IPDA) | 3 |
| silane terminated polymer | silane terminated polyether | 13.5 |
| amine curing agent | amino silane | 1.5 |
| Intumescent additive | Ammonium polyphosphate (APP) | 30 |
| | Melamine | 10 |
| | Pentaerythritol | 7 |
| | Titanium dioxide | 7 |
| | Zinc borate | 5 |
| Processing aid | Solvent | 7 |
| | rheology modifier | 1.5 |
| | dispersing agent | 0.5 |

### Reinforcing Layer

The reinforcing layer is in the form of a reinforcing sheet comprising a fabric. In this example, the fabric is glass paper. The fabric has a weight of 50 to 250 gsm.

Example 4 provides insulation and heat absorption during a thermal runaway event.

In this example, the in use outermost layer of the protective structure is the functional layer comprising the intumescent additive. The intumescent additive will expand by three times or more to provide a low-density char. This is very insulative but is vulnerable to erosion, therefore it is not well suited to areas close to the initial vent where gas velocities are high.

The reinforcing layer here is much less critical because it is not intended to resist penetration. Typically, the reinforcing layer is a thinner and cheaper layer (compared to examples 1 and 2 above), for example glass paper. The function of the reinforcing layer is largely to provide a substrate to lay the functional layer (i.e., intumescent film) down onto, and also to provide a keying layer for the adhesive film (if present).

### Protective Structure (Example 5)

A fifth example of a protective structure was made up of a functional layer, a reinforcing layer, and optionally an adhesive layer for attaching the protective structure to an internal surface of a battery enclosure.

In this example, the reinforcing layer provides an in use outermost layer of the protective structure and is exposed to an internal environment of the battery enclosure.

If present, the adhesive layer provides an in use innermost layer and may comprise a film of contact adhesive with protective film (i.e., a double-sided adhesive film) that allows easy bonding to the surface to be protected. The effect can also be achieved by mechanical fix or application of wet contact adhesive.

### Functional Layer

The functional layer is the cured reaction product of a mixture having the components listed below. In example 5, the functional layer comprises an intumescent additive dispersed in the cured polymer.

| | | Quantity |
|---|---|---|
| Component | Specific example of component | (wt. %) |
| Curable silicone polymer | Vinyl terminated | 28 |
| | polydimethylsiloxane | |
| Silicone crosslinker & | Polydimethylhydrogen siloxane | 3 |
| catalyst | with hydrosilylation catalyst | |
| Intumescent additive | Ammonium polyphosphate (APP) | 30 |
| | Melamine | 10 |
| | Pentaerythritol | 9 |
| | Titanium dioxide | 9 |
| | Zinc borate | 2 |
| Processing aid | Solvent | 9 |

### Reinforcing Layer

The reinforcing layer is in the form of a reinforcing sheet comprising a fabric. In this example, the fabric is made from glass fibers, typically high silica glass. The fabric has a weight of 200 to 1600 gsm, and may have a weight of 600 gsm. The fabric is a high temperature fabric or felt with a significant thickness capable of resisting a 1200° C. gas jet without melting.

Example 5 combines the functional layer of examples 3 and 4 with the reinforcing layer of examples 1 and 2. In example 5, however, the in use outermost layer of the protective structure which is exposed to the internal environment of the battery enclosure is the reinforcing layer.

The functional layer comprising the intumescent additive is applied to the inner face of the fabric of the reinforcing layer. Although the char formed from the functional layer is still vulnerable to erosion, it is protected by the outer reinforcing layer in the first exposure to the vent gasses and can then react safely to the prolonged heat and insulate the substrate.

In examples 1 to 5 above, the functional layer comprises a cured polymer formed from mixtures comprising one or more curable polymers and crosslinkers. The crosslinkers include crosslinking functional groups and the curable polymers include crosslinkable functional groups. In the examples above, the functional layer can be formed by combining a first part of the mixture with a second part of the mixture. The first part comprises the curable polymer for forming the cured polymer and the second part comprises the crosslinker. The second part may also optionally include a catalyst. The remaining components (i.e., additives) are provided in either the first and/or second parts. The first and/or second parts may also comprise additional components *i.e., additives) as is conventional, such as wetting agents, dispersing agents, surfactants, solvents, or rheology modifiers.

The reaction to form the functional layer may be initiated by combining the first and second parts. The curable polymer reacts with the crosslinker to form a cured polymer. The example functional layers therefore comprise a cured polymer with the remaining ingredients (i.e., additives) being dispersed in the cured polymer.

In other examples, the functional layer may be formed from a one-part mixture, for example, which cures in response to exposure to an environmental stimulus. The environmental stimulus may be UV light, or alternatively the presence of moisture and/or oxygen on exposure to the atmosphere. The curable polymer and crosslinker could be exposed to the atmosphere following the evaporation of an organic solvent in the mixture, or by opening a container holding the mixture. The environmental stimulus activates the crosslinker including crosslinking functional groups and/or the curable polymer including crosslinkable functional groups, to enable the curing reaction to proceed. Where the functional layer is formed from a one-part mixture, in some examples the crosslinker could be integrated into the curable polymer molecule, such that the polymer is self-crosslinking (i.e., the crosslinker including crosslinking functional groups and the curable polymer including crosslinkable functional groups are present in the same molecule). Example cured polymers formed from one-part mixtures include drying oils or alkyd resins.

In some examples, the mixture comprises 10 to 50 wt. % of the curable polymer and crosslinker. Preferably, the mixture comprises 20 to 40 wt. % of the curable polymer and crosslinker.

In some examples, the curable polymer comprises a silicone polymer, and the crosslinker comprises a silicone crosslinker, thereby forming a cured silicone polymer upon curing. Silicone polymer is particularly flexible, and this property is imparted on the functional layer. The resulting flexibility of the functional layer enables the protective structure to readily adapt to curved surfaces within a battery enclosure.

A catalyst, such as a hydrosilylation catalyst may also be added to the mixture to accelerate the curing process. Alternatively, or additionally, the curable polymer could comprise an epoxy and/or a silane terminated polymer with a corresponding crosslinker, as illustrated by examples 2 and 4 above. In examples 2 and 4, the mixture comprises Bisphenol A and silane terminated polyether curable polymers, along with isophorone diamine and aminopropyltrimethoxysilane crosslinkers.

In some examples, the functional layer comprises from 3 to 40 wt. % of the fire retardant. Preferably, the functional layer comprises from 5 to 30 wt. % of the fire retardant. Most preferably, the functional layer comprises from 15 to 25 wt. % of the fire retardant.

Preferably, the fire retardant comprises an endothermic additive, such as an inorganic salt. The inorganic salt may be aluminum trihydroxide, magnesium dihydroxide or ammonium polyphosphate. In some examples, the fire retardant comprises a further endothermic additive. The further endothermic additive could be for instance a different inorganic salt. In examples 1 and 2 above, the fire retardant comprises aluminum trihydroxide and ammonium polyphosphate.

In some examples, the functional layer comprises 3 to 45 wt. % of the refractory material. Preferably, the functional layer comprises 5 to 22 wt. % of the refractory material.

In some examples, the refractory material comprises a mineral or a ceramic. Preferably, the refractory material comprises mica, clay, organoclay, talc, ceramic fibers or a borate. The functional layer may comprise from 3 to 40 wt. % mica flakes. Preferably, the functional layer comprises from 5 to 20 wt. % mica flakes. In some examples, the functional layer also comprises up to 5 wt. % organoclay, which is also a refractory material. Preferably, the functional layer comprises from 0.5 to 2 wt. % organoclay. In examples 1 and 2 above, the organoclay is ADINS® Clay 20 by Tolsa®.

In some examples, the functional layer comprises a vitrifiable additive dispersed in the cured polymer. Preferably, the vitrifiable additive comprises a glass frit or a ceramifying agent. The functional layer may comprise from 5 to 35 wt. % of the vitrifiable additive. Preferably, the functional layer comprises from 15 to 25 wt. % of the vitrifiable additive.

The functional layer may comprise from 1 to 75 wt. % of the intumescent additive. Preferably, the functional layer comprises from 10 to 60 wt. % of the intumescent additive.

In some examples, the intumescent additive comprises a phosphorus containing compound, a gas source, and a carbon source. The phosphorus containing compound could be for instance ammonium polyphosphate, triphenyl phosphate, or aluminum phosphinate. The gas source could be for instance melamine or boric acid. The carbon source could be for instance pentaerythritol or tris-(2-hydroxyethyl) isocyanurate.

The intumescent additive may comprise from 10 to 40 wt. % ammonium polyphosphate. Preferably, the intumescent additive may comprise from 20 to 35 wt. % ammonium polyphosphate. The intumescent additive may comprise from 5 to 25 wt. % melamine. Preferably, the intumescent additive may comprise from 7 to 15 wt. % melamine. The intumescent additive may comprise from 2 to 25 wt. % pentaerythritol. Preferably, the intumescent additive may comprise from 2 to 12 wt. % pentaerythritol. The intumescent additive may comprise from 2 to 25 wt. % titanium dioxide. Preferably, the intumescent additive may comprise from 2 to 12 wt. % titanium dioxide. The intumescent additive may comprise from 0.5 to 10 wt. % zinc borate. Preferably, the intumescent additive may comprise from 0.5 to 5 wt. % zinc borate.

In some examples, the functional layer may comprise reinforcing fibers dispersed in the cured polymer. The reinforcing fibers act as a reinforcing component. The reinforcing fibers may be basalt fibers, glass fibers, ceramic fibers, carbon fibers, and/or mineral fibers.

In some examples, the mixture for forming the functional layer may comprise one or more processing aids. The one or more processing aids may comprise at least one of a solvent, a rheology modifier or a dispersing agent. The mixture may comprise up to 20 wt. % of the solvent, and preferably the mixture comprises 5 to 11 wt. % of the solvent. The mixture may comprise up to 2 wt. % of the rheology modifier, and preferably the mixture comprises up to 0.7 wt. % of the rheology modifier. The mixture may comprise up to 5 wt. % of the dispersing agent, and preferably the mixture comprises up to 1.5 wt. % of the dispersing agent. Examples 1 and 2 each include a dimethyl carbonate solvent. Example 2 includes a Rheobyk® 7420 ES rheology modifier and a SILRES® BS 1316 dispersing agent.

In the examples described above, the functional layer is formed by curing a mixture comprising: at least one curable polymer for forming the cured polymer; a crosslinker for forming the cured polymer; and either a fire retardant and a refractory material or an intumescent additive. The mixture may comprise further components as indicated above in relation to examples 1 to 5.

In other examples, the functional layer may be formed by drying a mixture comprising: cured polymer particles dispersed within a solvent; and either a fire retardant and a refractory material or an intumescent additive. The mixture may comprise further components as indicated above in relation to examples 1 to 5. The functional layer is formed once the solvent has evaporated. The solvent may be a volatile organic solvent (such as hexane or xylene) or water. The cured polymer particles could be for instance made from acrylic resin.

### Example Method

Examples of the disclosure also provide a method of forming protective structures according to examples of the disclosure. The method comprises mixing the components, for instance of any of the mixtures described herein, for forming the functional layer. The mixture comprises at least one curable polymer and a crosslinker for forming the cured polymer. The method further comprises allowing the mixture to cure in the presence of a reinforcing layer to provide the protective structure. Where the mixture comprises the cured polymer particles dispersed within a solvent, the method further comprises allowing the mixture to dry in the presence of a reinforcing layer to provide the protective structure.

In a first embodiment of the method, the method comprises applying the mixture for forming the functional layer to a first side of a reinforcing sheet described herein and allowing the mixture to dry or cure. Once the mixture has been applied to the reinforcing sheet, the mixture may be smoothed over to ensure a uniform thickness of the mixture on the reinforcing sheet before the mixture dries or cures.

In some examples of the first embodiment, the mixture is applied to the reinforcing sheet by hand, then smoothed over by hand using a film casting knife. In other examples, the reinforcing sheet is fed over one or more rollers, and the mixture is applied via one or more nozzles positioned above the reinforcing sheet passing over the rollers. Once the mixture has been applied, the sheet may be fed between a roller and a blade to smooth the mixture over the sheet, which is known as a “knife-over-roll” process. The blade can be positioned a predetermined distance away from the roller to ensure a uniform coating of the mixture on the sheet. The coated sheet is then optionally transferred to an oven to accelerate curing and/or drying. The oven may be at a temperature of 100° C. to 200° C., such as 160° C.

In a second embodiment of the method, the method comprises adding reinforcing fibers to the mixture. In the second embodiment, the mixture for forming the functional layer may be applied to a sheet/layer and be allowed to cure/dry using the same example processes as described in relation to the first embodiment above, except in the second example the mixture is applied to a removable backing sheet or an adhesive layer, rather than directly to the reinforcing sheet described in the first embodiment. After the mixture is cured and/or dried, the resulting functional layer can be applied to a reinforcing sheet to provide a protective structure. In such examples, a reinforcing component is also dispersed in the cured polymer of the functional layer.

In some examples, an adhesive layer may be added to the protective structure after the curable polymer has cured and/or dried. In one example, double-sided adhesive tape is applied to one side of the protective structure. Double-sided adhesive tape is usually provided with a non-adhesive film protecting each side of the adhesive tape. The non-adhesive film on only one side of the tape may be removed when applying the tape to the protective structure, such that the other side of the tape remains non-adhesive, thereby enabling easy transport. When the protective structure is then being applied to a surface of a battery enclosure, the non-adhesive film on the other side of the tape can be removed. In another example, an adhesive spray is applied to the protective structure, instead of the adhesive tape. In some examples, the adhesive is preferably applied to the reinforcing layer, rather than the functional layer.

In examples wherein the protective structure is for protecting an internal surface of a battery enclosure, the protective structure may be provided in the form of a rolled sheet, then cut to fit an internal surface of a battery enclosure, such as the inner face of a wall of a battery enclosure. Alternatively, the protective structure may be provided as a pre-cut part to fit to a wall of a battery enclosure. The protective structure could be cut into multiple parts to cover complex shapes.

The protective structure is then attached to an internal surface of a battery enclosure, such as a wall of a battery enclosure. The protective structure may be applied to the internal face of the wall of a battery enclosure, and in some examples the protective structure covers substantially the whole of the face of the wall. In other examples, the protective structure covers only a portion of the wall, which could be a vulnerable portion of the wall. The vulnerable portion of the wall may be located such that it would be directly impacted by venting gas from a thermal runaway event. The battery enclosure may form part of a vehicle, such as an electric car.

In examples wherein the protective structure is for protecting an internal surface of a battery enclosure, and where the protective structure comprises an adhesive layer, the protective structure may be attached to an internal surface of the battery enclosure using the adhesive. Alternatively, or additionally, the protective structure may be attached to an internal surface mechanically. The mechanical attachment could comprise fastening the protective structure to the wall using one or more fasteners, such as a staples or rivets. Alternatively, a slot could be provided in the wall of the enclosure for insertion of at least part of the protective structure. In other examples, the protective structure may be over-molded with a battery enclosure. In the case of over-molding, materials forming the protective structure are placed into a tool and the liquid resin (or polymer melt, or SMC/DMC preform) that makes up the structure or part of the battery enclosure is injected or placed. The tool is compressed, or resin allowed to cure, melt to cool etc. Then, when the structure or part relating to the battery enclosure is removed from the tool, the protective structure has become a permanent layer of the structure or part of the battery enclosure.

There is thus described a protective structure, a battery enclosure comprising the protective structure, a vehicle comprising the battery enclosure, a method of forming the protective structure, and a method of protecting a battery enclosure with a number of advantages as detailed above and below.

The battery enclosure is resistant to the high heat, high pressure and high mechanical stress caused by a thermal runaway event within the enclosure because of the provision of the described protective structure. The protective structure can be readily applied to a surface of the battery enclosure. For instance, a single user can apply the protective structure by hand, without requiring complex equipment. Furthermore, the protective structure is lower cost, is less bulky and is lower weight than known solutions of containing a thermal runaway of a battery enclosure. By using a functional layer, the thickness of the protective structure can be tightly controlled across its breadth, to maintain consistent protection, and avoid weak spots. The functional layer of the protective structure also prevents fibers from shedding, for instance, into the battery enclosure.

Accordingly, examples of the disclosure protect battery pack casings (i.e., battery enclosures) from either internal thermal runaway or attack by an external fire that would lead to a thermal runaway. Battery pack casings are typically made from steel sheet, aluminum, SMC/DMC, composite or even thermoplastic.

A thermal runaway typically starts in a single cell but is likely to develop to include most or all of the cells in the pack. When the first cell is triggered (by heat, overcharge, internal short circuit, external short circuit or mechanical damage) there will a very rapid vent of very hot gasses and molten metal (circa 1200 C). This jet is capable of cutting through internal partitions in battery packs to trigger other cells or cutting through the external casing resulting in an uncontained fire. Where elements of the battery pack are directly exposed to the vent jet they need to be protected against penetration or destruction by protective layers. Even in the case of steel, which will not be penetrated by the jet, the heating effect will result in such high temperatures on the other face of the partition or casing that it is likely that materials outside the pack will be ignited.

Protection against penetration must be provided by a material that has good resistance to the ablative effects of the hot gas jet, typically resistance to very high temperature, formation of hard, glassy char, resistance to wear and some measure of insulation to protect the substrate. This is achieved at least by examples 1 and 2 above.

Some way away from the direct gas jet there may still be very high temperatures and turbulent flame as the emitted energy and materials spread through the open spaces in the pack and escape through pressure relief devices. This is known as the vent path. Typically, there will be vulnerable materials in the vent path such as insulated bus bars, wiring and circuitry/electronics, cooling pipes, electrical insulation layers and even the material of the battery casing or partitions within it may be vulnerable. This application does not require the same degree of resistance to penetration or erosion, but since the materials may be more vulnerable to temperature rise it is important that a good level of insulation and/or heat absorption is provided. This is achieved at least by examples 3 and 4 above.

A further application is seen where a high degree of insulation is required along with a high degree of resistance to erosion. This can occur where vulnerable components are very close to the initial vent site and also when multiple cells propagate within the pack the internal temperature rise can be very high and last for a prolonged period. This means that the pack casing needs to resist the initial damage from the direct vent but then also insulate the pack casing material and prevent it from melting (in the case of aluminum), or resin burn out (in the case of SMC/DMC, composite or polymer materials) or excessive heat transmission (particularly in the case of steel). Although this is a slower failure mode it can still result in the structural destruction of the pack and an uncontained fire. This is achieved at least by example 5 above.

Although embodiments of the present invention have been described in the preceding paragraphs with reference to various examples, it should be appreciated that modifications to the examples given can be made without departing from the scope of the invention as claimed. For instance, the proportions of the respective components of the mixture for forming the functional layer can be varied to provide a required degree of protection of the battery enclosure, or to vary the flexibility of the protective structure. A different number or thickness of functional layers may be provided, for instance, to provide a different level of protection. The protective structure could be provided in a number of shapes. The protective structure might not be directly applied to the walls of the battery enclosure. For instance, the protective structure might be applied to a coating on the wall, such as an anti-corrosion coating. The protective structure might also be applied to an electromagnetic compatibility shield provided on the inside of the wall, rather than directly onto the wall. The battery enclosure may include lithium-ion cells or other types of battery cells. The battery enclosure could be used in a variety of applications, such as in an electric vehicle, in a home, in aerospace equipment, or in marine equipment.

The additives described herein may each include a single constituent or multiple constituents. For instance, the intumescent additive may include multiple constituent parts, in the form of a phosphorus containing compound, a gas source, and a carbon source.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Features described in the preceding description may be used in combinations other than the combinations explicitly described above. For example, the layers may be provided in a different order. A single protective structure may be applied to a single wall of the enclosure. Multiple protective structures may be applied to a single wall, or a single protective structure may be applied to multiple walls. One, some, or all of the internal surfaces of the walls of the battery enclosure may be covered by the protective structure(s).

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning, then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the applicant may seek protection via the claims in respect of any patentable feature or combination of features hereinbefore referred to and/or shown in the drawings whether or not emphasis has been placed thereon.

1. A protective structure for protecting a battery enclosure, the protective structure comprising:
a functional layer comprising a cured polymer, wherein the functional layer comprises a fire retardant and a refractory material dispersed in the cured polymer, or wherein the functional layer comprises an intumescent additive dispersed in the cured polymer; and
a reinforcing layer.

2. The protective structure according to claim 1, wherein the protective structure is for protecting an internal surface of a battery enclosure.

3. The protective structure according to claim 2, wherein in use, the functional layer of the protective structure is an outermost layer of the protective structure and is exposed to an internal environment of the battery enclosure.

4. The protective structure according to claim 2, wherein in use, the reinforcing layer of the protective structure is an outermost layer of the protective structure and is exposed to an internal environment of the battery enclosure.

5. The protective structure according to claim 1, wherein the reinforcing layer is in the form of a reinforcing sheet, the reinforcing sheet comprising a fabric or a mesh.

6. The protective structure according to claim 5, wherein the fabric or mesh is made at least partially from: glass fibers, basalt fibers, mineral fibers, ceramic fibers, carbon fibers, or steel.

7. The protective structure according to claim 5, wherein the reinforcing sheet comprises a fabric with a weight of 50 to 1600 gsm.

8. (canceled)

9. (canceled)

10. The protective structure according to claim 1, wherein the cured polymer comprises a silicone polymer, an epoxy resin, a silane terminated polymer resin, an acrylic resin, an alkyd resin, a vinyl acetate copolymer, or a combination thereof.

11. The protective structure according to claim 1, wherein the fire retardant comprises an endothermic additive.

12. The protective structure according to claim 11, wherein the endothermic additive comprises an inorganic salt.

13. (canceled)

14. The protective structure according to claim 1 any of the preceding claims, wherein the refractory material comprises mica, clay, organoclay, talc, ceramic fibers or a borate.

15. The protective structure according to claim 1, wherein the intumescent additive comprises a phosphorus containing compound, a gas source, and a carbon source.

16. (canceled)

17. The protective structure according to claim 1 any of the preceding claims, wherein the functional layer comprises a vitrifiable additive dispersed in the cured polymer, wherein the vitrifiable additive comprises a glass frit or a ceramifying agent.

18. (canceled)

19. The protective structure according to claim 1, wherein the protective structure further comprises an adhesive layer for attaching the protective structure to a surface of a battery enclosure.

20. (canceled)

21. (canceled)

22. (canceled)

23. A battery enclosure comprising the protective structure according to claim 1.

24. The battery enclosure according to claim 23, wherein the battery enclosure comprises at least a first wall, wherein the reinforcing layer is located at least partially between the first wall and the functional layer.

25. The battery enclosure according to claim 23, wherein the battery enclosure comprises at least a first wall, wherein the functional layer is located at least partially between the first wall and the reinforcing layer.

26. A vehicle comprising the battery enclosure according to claim 23.

27. A method for protecting a battery enclosure, the method comprising attaching the protective structure of claim 1 to a surface of a battery enclosure.

28. (canceled)

29. The protective structure according to claim 1, wherein the cured polymer comprises a silicone polymer.
